(19) United States
(12) Patent Application Publication
(10) Pub. No.: US 2013/0111169 A1
(43) Pub. Date: May 2, 2013

(54) ENGINE CONTROL UNIT FOR AN INTERNAL COMBUSTION ENGINE

(71) Applicant: Peter Poinstingl, Zwettl (AT)

(72) Inventor: Peter Poinstingl, Zwettl (AT)

(21) Appl. No.: 13/637,879

(22) PCT Filed: Mar. 31, 2011
(86) PCT No.: PCT/EP2011/055012

§ 371 Date: Dec. 5, 2012

(30) Foreign Application Priority Data
Apr. 1, 2010 (DE) 102010003587.4

(51) Int. Cl. G06F 12/14

(52) U.S. Cl. 711/163; 711/E12.091

(57) ABSTRACT

A control unit for an internal combustion engine including a microcontroller having an integrated memory for receiving memory contents, in which the microcontroller is configured so that, in a first operation, memory areas are definable for providing a final memory protection and/or memory areas are provided with a preliminary memory protection, and, in a second operation, the defined memory areas or the memory areas provided with a preliminary memory protection are providable with a final memory protection.

### FIELD OF THE INVENTION

The present invention relates to an engine control unit for an internal combustion engine including a microcontroller having an integrated memory for receiving memory contents.

### BACKGROUND INFORMATION

The function of an engine control unit of an internal combustion engine is to calculate output variables for actuators, such as injection nozzles or ignition systems, from a plurality of input signals, such as rotational speed, temperature, or pressure. For this purpose, a control unit includes a microcontroller having its own memory (so-called on-chip memory) in which the data, engine characteristic maps, and/or programs (in the following also referred to as memory contents) necessary for the calculation are stored.

When manufacturing the control unit, certain memory areas are programmed by the control unit manufacturer, usually a supplier, with programs (firmware), data, and/or engine characteristic maps. The programmed control unit is then delivered to the vehicle manufacturer who, if necessary, makes some changes to the data and the engine characteristic maps in order to ensure that the control unit and the internal combustion engine are optimally tuned. The data, engine characteristic maps, and/or programs are predefined based on intensive research and tests in such a way that the internal combustion engine works as component-conserving and environmentally friendly as possible. In particular, the data, engine characteristic maps, and/or programs are predefined in such a way that no damage occurs in the internal combustion engine even under extreme conditions. By appropriately reprogramming (so-called chip tuning) the microcontroller in the control unit, more or less pronounced performance enhancements are possible.

Chip tuning is, however, associated with considerable risk factors. For example, excessively high temperatures, pressures, and rotational speeds, as well as increased load on the drive train and the braking system, may result in defects. Furthermore, the exhaust gas values may deteriorate. For this reason, the control unit manufacturer undertakes measures to prevent the reprogramming of the control unit.

An engine control unit and a method for protecting such a control unit from manipulations are known from DE 102 38 095 A1, where encrypted data are stored in a memory chip on a printed circuit board of the engine control unit and the key used to encrypt the data includes at least one original module-specific identification of at least one of the modules of the control unit.

It is also common to program certain memory contents into one-time programmable (OTP) memory areas of the microcontroller. This is, however, associated with specific disadvantages. In particular, this may result in essential (program) parts in the memory of the control unit no longer being processable so that, in the most unfavorable case, control units might even have to be scrapped because it is no longer possible to update them. This is particularly problematic and results in high costs in the case of in-stock items with the supplier as well as in the case of control units which are already with the vehicle manufacturer.

### SUMMARY OF THE INVENTION

Therefore, the exemplary embodiments and/or exemplary methods of the present invention include providing a control unit with an efficient memory protection or manipulation protection, a change in the memory contents stored in the memory still being possible, at least in the sphere of influence of the control unit and/or vehicle manufacturer.

According to the exemplary embodiments and/or exemplary methods of the present invention, engine control units as well as methods for providing a final memory protection having the features of the independent patent claims are proposed for this purpose. Advantageous embodiments are the subject matter of the descriptions herein as well as of the following description.

The exemplary embodiments and/or exemplary methods of the present invention are based on a two-stage concept for providing memory protection. In the following, memory protection is to be understood as a read and/or write protection.

In a first alternative, the control unit manufacturer prepares the control unit or the memory areas in its microcontroller, the areas which are to be provided with a final memory protection being identified accordingly. Subsequently, the control unit is delivered to the vehicle manufacturer who intends to install the control unit into a vehicle at a later point in time. The final activation of the memory protection takes place only at the vehicle manufacturer, in particular prior to the delivery; in a particular embodiment, only a corresponding programming command, which then results in a final protection of the memory areas previously accordingly identified, must be transferred to the control unit.

In a second alternative, the control unit manufacturer provides the control unit or the memory areas in its microcontroller with a preliminary memory protection prior to delivering the control unit to the vehicle manufacturer. The preliminary memory protection distinguishes itself in that it may be cancelled. Advantageously, this may only be done by the control unit manufacturer, in particular by providing a secret key. The preliminary memory protection may advantageously be cancelled using a key within the scope of a common and established encryption process, for example AES. Advantageously, the final activation of the memory protection, in turn, takes place only at the vehicle manufacturer, in particular prior to the delivery; in a particular embodiment, only a corresponding programming command, which then converts the preliminary protection into a final protection, must be transferred to the control unit.

A combination of the two alternatives just described may also be provided.

With the aid of the measure according to the exemplary embodiments and/or exemplary methods of the present invention, control units may be provided with an efficient memory protection in order to protect them, in particular, against manipulations, e.g., chip tuning, while still providing the control unit manufacturer as well as the vehicle manufacturer with the possibility of reading and/or reprogramming certain memory areas. The advantages offer the vehicle manufacturer, in particular, the possibility of optimizing the adaptation of the control unit to the internal combustion engine until the delivery of the vehicle. In-stock items with the control unit manufacturer may, for example, be regularly updated.

Further advantages and embodiments of the present invention result from the description and the drawings.

It is understood that the above-mentioned features and the features to be elucidated below are usable not only in the given combination, but also in other combinations or alone without departing from the scope of the exemplary embodiments and/or exemplary methods of the present invention.

The exemplary embodiments and/or exemplary methods of the present invention are schematically illustrated in the drawing on the basis of exemplary embodiments and described in greater detail in the following with reference to the drawing.

### BRIEF DESCRIPTION OF THE DRAWINGS

FIG. 1 shows one specific embodiment of a control unit according to the present invention.

FIG. 2 shows, with reference to a flow chart, different alternatives of how a control unit according to the present invention may be set up.

### DETAILED DESCRIPTION

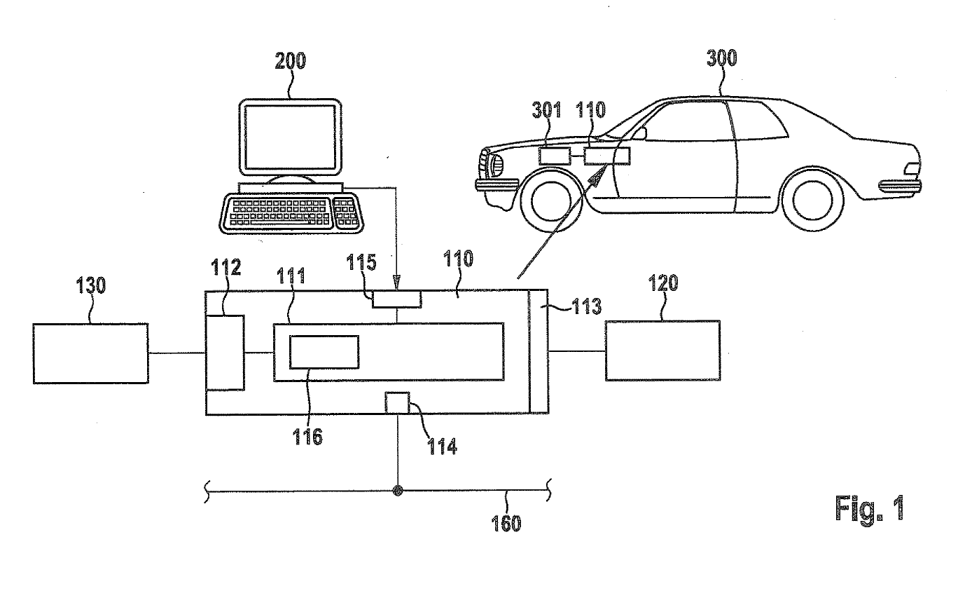

FIG. 1 shows, schematically and in the form of a circuit diagram, a control unit 110 for operating a functional unit 120, e.g., an actuator or an electric motor. Control unit 110 is located in a motor vehicle 300 and has a function calculator (arithmetic unit or microcontroller) 111 which is connected to an interface 112 for receiving sensor signals of a sensor 130, for example. Function calculator 111 processes the sensor signals and controls based on the processing and its programming a circuit 113 for operating functional unit 120. For this purpose, function calculator 111 has a memory 116 in which memory contents are stored, including data engine characteristic maps, and/or programs. Functional unit 120 may also include multiple functional units in order to control internal combustion engine 301 of vehicle 300, in particular.

Control unit 110 furthermore has an interface 114 for coupling to a communication bus 160 as well as a service interface 115 for reading out and writing in memory contents of function calculator 111. For reading out and writing in memory contents, interface 115 is connected to a computer 200, for example.

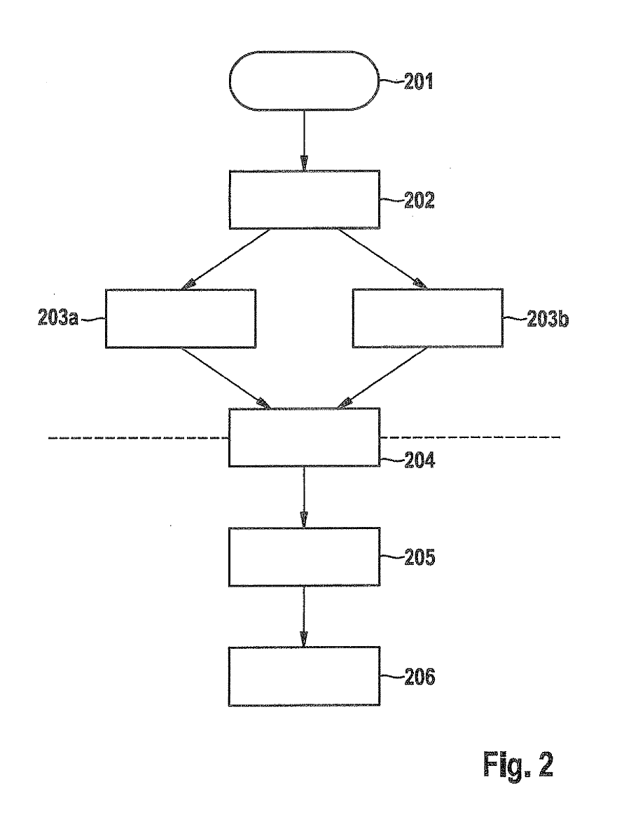

In the example shown here, function calculator 111 is set up according to one of the alternatives of the present invention explained with reference to FIG. 2, this alternative being described in the following.

In a preceding step 201, the control unit is manufactured and assembled at the control unit manufacturer, usually a supplier.

In a step 202, memory contents, such as in particular data, engine characteristic maps, and/or programs, are written into memory 116 of function calculator 111.

According to one alternative, certain memory contents, which are to be provided with a final memory protection, in particular a read and/or write protection, at a later point in time, are defined in a step 203a.

According to another alternative, certain memory contents are provided with a preliminary memory protection in a step 203b.

In a step 204, control unit 110 leaves the sphere of influence of the supplier and is delivered to a vehicle manufacturer.

In a step 205, control unit 110 is installed in a vehicle 300. Due to the fact that the memory protection is not yet final, it is now possible to read and/or change the memory contents of the control unit in order to optimally adapt these to internal combustion engine 301 to compensate for manufacturing variations.

In a step 206, control unit 110 or its function calculator 111 is finally prompted by a corresponding programming command, e.g., via service interface 115, to set the final memory protection and thus to provide a read and/or write protection as a manipulation protection or access protection. For this purpose, the function calculator is advantageously set up irrevocably in such a way that it no longer executes writing and/or reading commands for the corresponding memory areas.

It is pointed out that steps 204 and 205 are only optional steps which are used, in particular, to better illustrate the benefits of the present invention.

1-7. (canceled)

8. A control unit for an internal combustion engine, comprising:
a microcontroller having an integrated memory for receiving memory contents;
wherein the microcontroller is configured so that, in a first operation, memory areas are definable for providing a final memory protection, and
wherein, in a second operation, the defined memory areas are providable with the final memory protection.

9. The control unit of claim 8, wherein the microcontroller is configured so that, in a first operation, memory areas may be provided with a preliminary memory protection and, in a second operation, the memory areas provided with a preliminary memory protection may be provided with a final memory protection.

10. The control unit of claim 9, wherein the microcontroller is configured so that it cancels the preliminary memory protection upon receipt of a corresponding programming command.

11. The control unit of claim 10, wherein the microcontroller is configured so that the preliminary memory protection is canceled using a key within the scope of an encryption process.

12. The control unit of claim 8, wherein the microcontroller is configured so that it provides the final memory protection upon receipt of a corresponding programming command.

13. The control unit of claim 8, wherein the memory protection includes at least one of a read protection and a write protection.

14. A method for providing a final memory protection for memory areas of a control unit, the method comprising:
performing, with a microcontroller, a first operation; and
performing, with the microcontroller, a second operation, wherein the first operation and the second operation are performed during different programming sessions;
wherein a microcontroller is configured so that the first operation includes defining, memory areas for providing a final memory protection,
wherein the microcontroller is configured so that the second operation includes providing the defined memory areas with the final memory protection, and
wherein the control unit, which is for an internal combustion engine, includes a microcontroller having an integrated memory for receiving memory contents.

15. The control unit of claim 9, wherein the microcontroller is configured so that it cancels the preliminary memory protection upon receipt of a corresponding programming command, which includes a secret key.
